(19) United States
(12) Patent Application Publication
(10) Pub. No.: US 2022/0413292 A1
(43) Pub. Date: Dec. 29, 2022

(54) VIRTUAL REALITY HEAD MOUNTED DISPLAY

(71) Applicant: HTC Corporation, Taoyuan City (TW)

(72) Inventors: Meng-Che Tsai, Taoyuan City (TW); Kuei-Chun Liu, Taoyuan City (TW)

(73) Assignee: HTC Corporation, Taoyuan City (TW)

(21) Appl. No.: 17/361,326

(22) Filed: Jun. 29, 2021

(51) Int. Cl. G02B 27/01; G02B 27/14; G02B 27/09

(52) U.S. Cl. CPC G02B 27/0172; G02B 27/142; G02B 27/0955; G02B 2027/0123; G02B 2027/0187

(57) ABSTRACT

A virtual reality head mounted display includes a first display, a first lens, a second lens, a beam splitter coating and a second display. The first display generates a first display image beam on an active surface. The first lens has a first surface facing the active surface of the first display and a second surface opposite to the first surface. The second lens has a third surface and an opposite fourth surface. The beam splitter coating is disposed between the second surface of the first lens and the third surface of the second lens. The third surface of the second lens is attached to the second surface of the first lens through the beam splitter coating. The second display has an active surface facing the fourth surface of the second lens. The second display generates a second display image beam on the active surface.

### TECHNICAL FIELD

The disclosure relates to a virtual reality head mounted display, and in particular, to a virtual reality head mounted display in which a field of view can be expanded.

### DESCRIPTION OF RELATED ART

Large field of view (FOV) and compact size are important targets for current virtual reality head mounted displays. Moreover, there are many discussions about the design of multi-depth display effects. For example, by using multiple image planes to solve the vergence-accommodation conflict, visual discomfort in wearing a head mounted display can be effectively relieved. However, a multi-depth display architecture tends to increase the number of components and the volume of a head mounted display. As a result, it is hard to avoid visual discomfort such as dizziness while obtaining lightweight and compact wearing comfort.

### SUMMARY

The disclosure provides a virtual reality head mounted display which meets the demands for large viewing angle, compact size and support of multi-depth display while maintaining a light weight.

The virtual reality head mounted display of the disclosure includes a first display, a first lens, a second lens, a beam splitter coating and a second display. The first display has an active surface. The first display is a transparent display. The first display generates a first display image beam on the active surface thereof. The first lens has a first surface facing the active surface of the first display and a second surface opposite to the first surface. The second lens has a third surface and a fourth surface opposite to each other. The beam splitter coating is disposed between the second surface of the first lens and the third surface of the second lens. The third surface of the second lens and the second surface of the first lens are attached to each other through the beam splitter coating. The first lens is a convex lens, and the second lens is a concave lens or a convex lens. The second display has an active surface facing the fourth surface of the second lens. The second display generates a second display image beam on the active surface thereof.

Based on the above, in the disclosure, the first lens, the beam splitter coating, and the second lens are disposed to be attached to each other. In addition, the first display image beam generated by the first display is reflected, and the second display image beam generated by the second display is transmitted. In this way, a multi-level display effect is effectively provided and the field of view of the head mounted display is expanded without increasing the size of the head mounted display. The display quality can be effectively improved on the premise of a lightweight and slim design.

### BRIEF DESCRIPTION OF THE DRAWINGS

FIG. 1 is a schematic diagram of a head mounted display according to an embodiment of the disclosure.

FIG. 2 is a schematic diagram of optical paths of lights generated from a first lens, a second lens, and a beam splitter coating in a head mounted display according to an embodiment of the disclosure.

FIG. 3A to FIG. 3C are schematic diagrams of transmission of an image beam according to an embodiment of the disclosure.

FIG. 3D to FIG. 3F are schematic diagrams of transmission of an image beam according to another embodiment of the disclosure.

FIG. 4A and FIG. 4B are schematic diagrams respectively illustrating different implementations of a head mounted display according to another embodiment of the disclosure.

### DESCRIPTION OF THE EMBODIMENTS

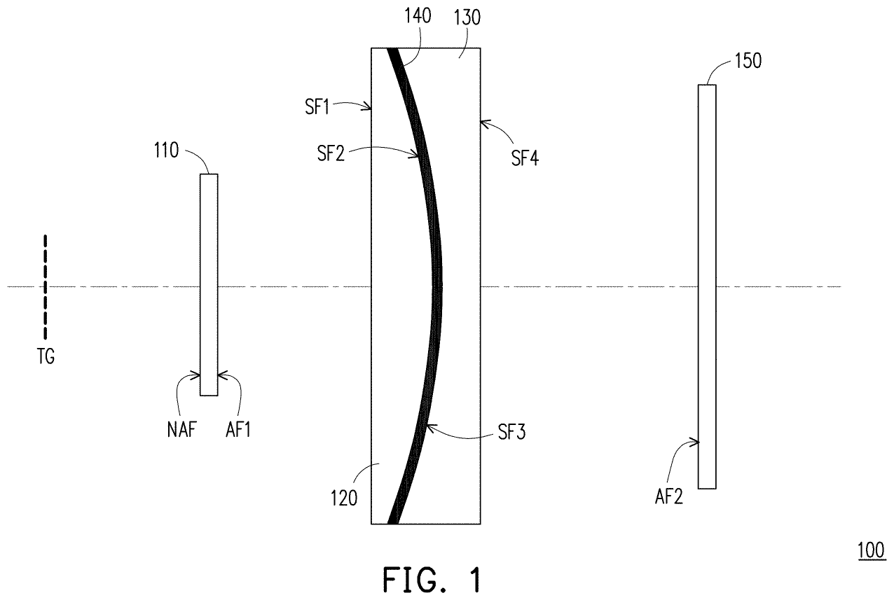

Referring to FIG. 1, FIG. 1 is a schematic diagram of a head mounted display according to an embodiment of the disclosure. A head mounted display 100 includes a first display 110, a first lens 120, a second lens 130, a beam splitter coating 140 and a second display 150. The first display 110 may be a transparent display. The first display 110 has an active surface AF1. The first display 110 is configured to generate a first display image beam on the active surface AF1. The first lens 120 has a first surface SF1 and a second surface SF2. The first surface SF1 of the first lens 120 faces the active surface of the first display 110. The second surface SF2 of the first lens 120 is opposite to the first surface SF1 the first lens 120. The second lens 130 has a third surface SF3 and a fourth surface SF4 opposite to each other. The beam splitter coating 140 is disposed between the second surface SF2 of the first lens 120 and the third surface SF3 of the second lens 130. In the embodiment, the third surface SF3 of the second lens 130 and the second surface SF2 of the first lens 120 are attached to each other through the beam splitter coating 140.

In the embodiment, the first lens 120 is a convex lens, and the second lens 130 is a concave lens. The first display image beam generated on the active surface AF1 of the first display 110 may be projected on the first surface SF1 of the first lens 120. The first display image beam may be further transmitted to the beam splitter coating 140 on the second surface SF2 of the first lens 120. The beam splitter coating 140 may reflect the received first display image beam to generate a reflection display image beam, and may cause the reflection display image beam to be transmitted through the first display 110 to be projected to a target region TG. The target region TG is an exit pupil position of the head mounted display 100, corresponding to a position of an eyeball of a user of the head mounted display 100. The eyeball of the user of the head mounted display 100 faces a non-active surface NAF1 of the first display 110.

Furthermore, the second display 150 has an active surface AF2 facing the fourth surface SF4 of the second lens 130. The active surface AF2 of the second display 150 is configured to generate a second display image beam and project the generated second display image beam to the fourth surface SF4 of the second lens 130. In the embodiment, a focused image beam may be generated according to the second display image beam by a focusing effect of the second lens 130 and the first lens 120. The focused image beam may be transmitted to penetrate through the first display 110 and transmitted to the target region TG.

It should be noted that in the embodiment, the first surface SF1 of the first lens 120 may have a first curvature CR1, and the second surface SF2 of the first lens 120 may have a second curvature CR2. An absolute value of the first curvature CR1 is less than an absolute value of the second curvature CR2. The third surface SF3 of the second lens 130 may have a third curvature CR3, and the fourth surface SF4 of the second lens 130 may have a fourth curvature CR4. In addition, the first curvature CR1 may be the same as the fourth curvature CR4, and a sum of the second curvature CR2 and the third curvature CR3 may be 0.

Specifically, the second surface SF2 of the first lens 120 may be a convex surface, and the third surface SF3 of the second lens 130 may be a concave surface. Furthermore, the first surface SF1 of the first lens 120 and the fourth surface SF4 of the second lens 130 may be flat surfaces having the same curvature or curved surfaces having the same curvature.

Incidentally, in the embodiment, the first display 110, the first lens 120, the beam splitter coating 140, and the second lens 130 may be disposed in a tube of the head mounted display 100.

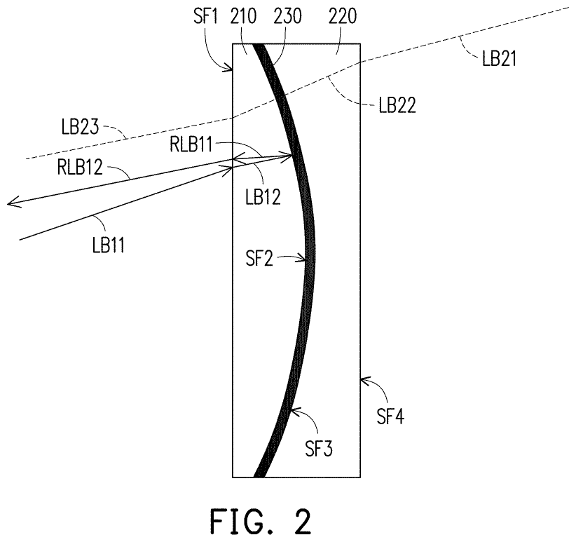

Referring to FIG. 2 below, FIG. 2 is a schematic diagram of optical paths of lights generated from a first lens, a second lens, and a beam splitter coating in a head mounted display according to an embodiment of the disclosure. In FIG. 2, a first lens 210 has the first surface SF1 and the second surface SF2 opposite to each other. A second lens 220 has the third surface SF3 and the fourth surface SF4 opposite to each other. A beam splitter coating 230 is provided between and glued to the second surface SF2 of the first lens 210 and the third surface SF3 of the second lens 220. In addition, the second surface SF2 of the first lens 210 is a convex surface, and the third surface SF3 of the second lens 220 may be a concave surface.

In FIG. 2, a light beam LB11 is projected on the first surface SF1 of the first lens 210. The first lens 210 deflects the light beam LB11 to generate a light beam LB12. The light beam LB12 travels in the first lens 210 and is transmitted to the beam splitter coating 230 on the second surface SF2 of the first lens 210. The beam splitter coating 230 reflects the light beam LB12 and generates a reflection light beam RLB11. The reflection light beam RLB11 travels from the second surface SF2 of the first lens 210 toward the first surface SF1 of the first lens 210, and is deflected on the first surface SF1 of the first lens 210 such that a reflection light beam RLB12 is generated. The reflection light beam RLB12 may be projected to the target region.

In addition, another light beam LB21 may be transmitted onto the fourth surface SF4 of the second lens 220 from an outside of the fourth surface SF4 of the second lens 220. The second lens 220 may deflect the light beam LB21 to generate a light beam LB22 and cause the light beam LB22 to travel in the second lens 220 and to be transmitted to the beam splitter coating 230 on the third surface SF3 of the second lens 220. The beam splitter coating 230 may allow the light beam LB22 to penetrate therethrough and to be transmitted to the first lens 210. When the light beam LB22 is transmitted onto the first surface SF1 of the first lens 210, the optical path is deflected again, and a light beam LB23 is generated and transmitted out of the first lens 210. The light beam LB23 may be transmitted to the target region.

In the embodiment, the light beam LB11 may be the first display image beam generated by the first display 110 of the embodiment in FIG. 1. The light beam LB21 may be the second display image beam generated by the second display 150 of the embodiment in FIG. 1. The light beam RLB12 may be the reflection display image beam described in the embodiment of FIG. 1, and the light beam LB23 may be the focused image beam described in the embodiment of FIG. 1.

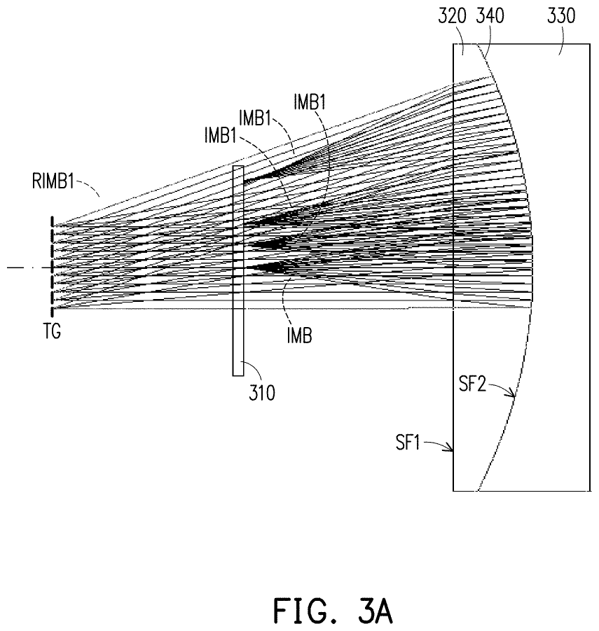

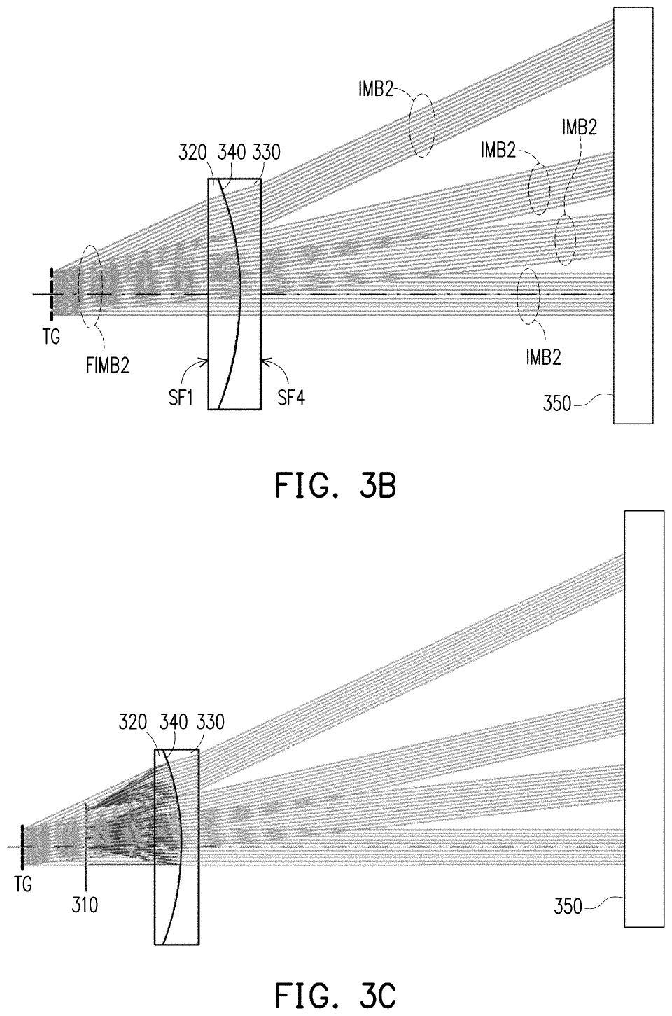

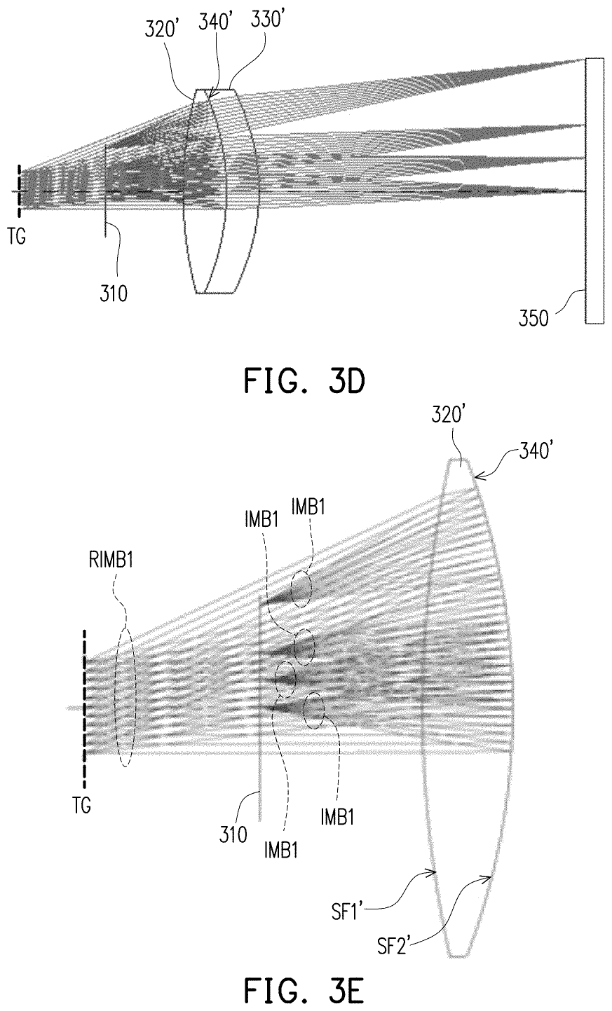

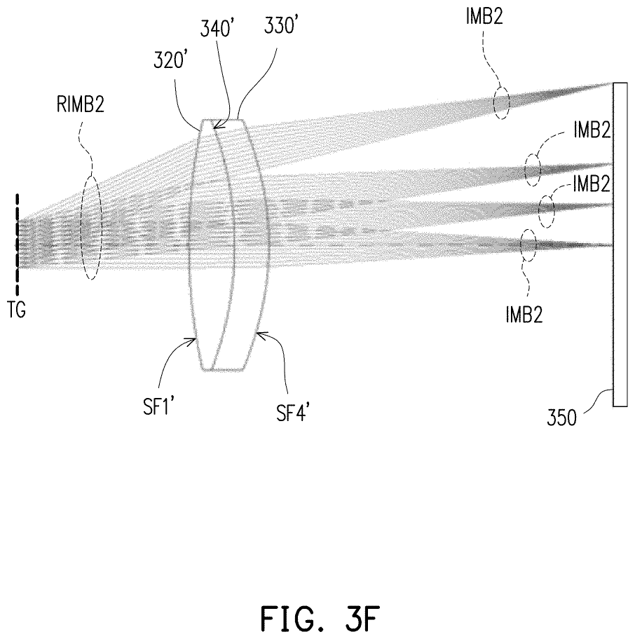

Referring to FIG. 3A to FIG. 3C below, FIG. 3A to FIG. 3C are schematic diagrams of transmission of an image beam according to an embodiment of the disclosure. In FIG. 3A, a first display 310 generates a first display image beam IMB1 on an active surface. The first display image beam IMB1 is projected to a first lens 320 and is transmitted through the first surface SF1 of the first lens 320 to the beam splitter coating 340 on the second surface SF2.

The beam splitter coating 340 is configured to reflect the first display image beam IMB1 to generate a reflection display image beam RIMB1. The reflection display image beam RIMB1 penetrates through the first surface SF1 of the first lens 320 and is transmitted to the target region TG behind the transparent display 310.

In the embodiment, the first display image beam IMB1 may include an image beam of a virtual reality image of a first level. Through the reflection display image beam RIMB1 transmitted to the target region TG, the user is able to observe an image of the first level of the virtual reality image without a problem.

In FIG. 3B, a second display image beam IMB2 may be generated by a second display 350 and is transmitted onto the fourth surface SF4 of a second lens 330 from an outside of the fourth surface SF4 of the second lens 330. The second display image beam IMB2 may penetrate through the fourth surface SF4 of the second lens 330, the beam splitter coating 340, and the first surface SF1 of the first lens 320 in sequence, and a focused image beam FIMB2 is generated by the focusing effect of the second lens 330 and the first lens 320. The focused light beam FIMB2 may be projected to the target region TG. In this way, the second display image beam IMB2 of a large range may be focused and projected to the target region TG such that the user can observe an image of a second level of the virtual reality image.

FIG. 3C is a combination of FIG. 3A and FIG. 3B. The first lens 320, the beam splitter coating 340, and the second lens 330 are disposed. The first display image beam generated by the first display 310 and the second display image beam generated by the second display 350 may be projected to the target region TG at the same time or at different times through a reflection display image beam and a focused image beam, respectively. In this way, the user is able to observe a multi-level virtual reality display image.

Referring to FIG. 3D to FIG. 3F below, FIG. 3D to FIG. 3F are schematic diagrams of transmission of an image beam according to another embodiment of the disclosure. The difference between FIG. 3D to FIG. 3F and FIG. 3A to FIG. 3C is that, in the embodiment, by a first lens 320′ being a convex lens, a beam splitter coating 340′, and a second lens 330′ being a convex lens, image beams generated by the first display 310 and the second display 350 are reflected and deflected, and a reflection image beam and a deflection image beam correspondingly generated may be transmitted to the target region TG.

In FIG. 3E, the first display image beam IMB1 is projected to the first lens 320′ by the first display 310 and is transmitted through a first surface SF1′ of the first lens 320′ to the beam splitter coating 340′ on a second surface SF2′. The beam splitter coating 340′ is configured to reflect the first display image beam IMB1 to generate the reflection display image beam RIMB1. The reflection display image beam RIMB1 penetrates through the first surface SF1′ of the first lens 320′ and is transmitted to the target region TG behind the transparent display 310.

In FIG. 3F, the second display image beam IMB2 may be generated by the second display 350, and is transmitted onto a fourth surface SF4′ of the second lens 330′ from an outside of the fourth surface SF4′ of the second lens 330′. The second display image beam IMB2 may penetrate through the fourth surface SF4′ of the second lens 330′, the beam splitter coating 340′, and the first surface SF1′ of the first lens 320′ in sequence, and the focused image beam FIMB2 is generated by the focusing effect of the second lens 330′ and the first lens 320′. The focused light beam FIMB2 may be projected to the target region TG.

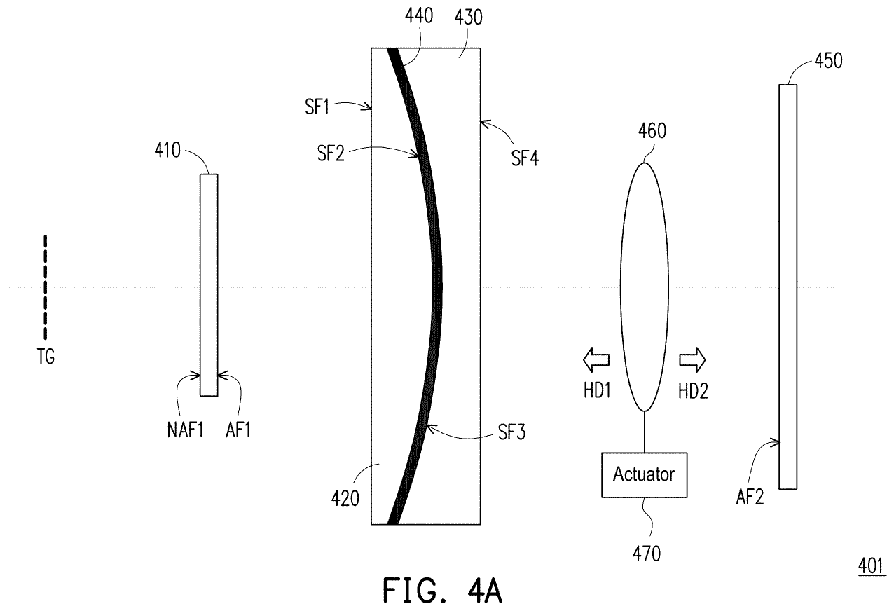

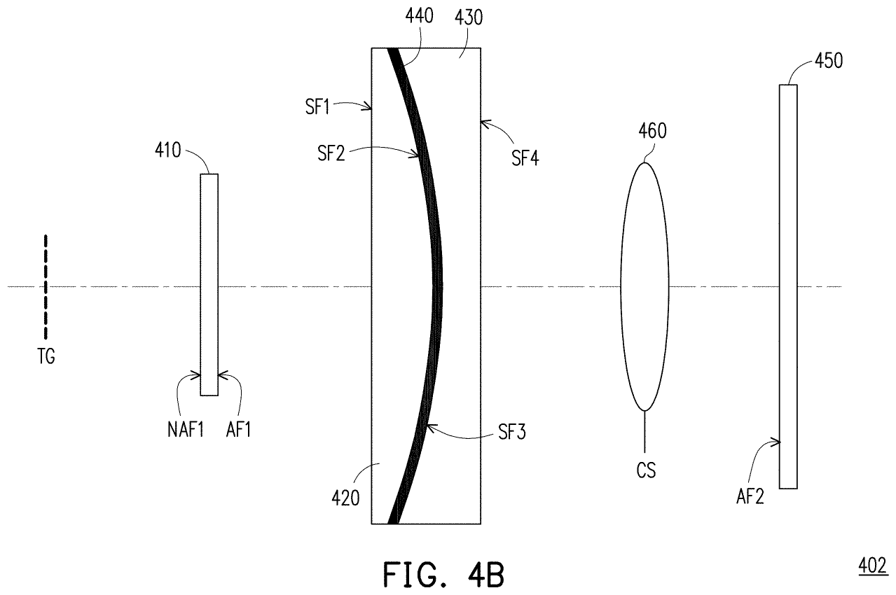

Referring next to FIG. 4A and FIG. 4B, FIG. 4A and FIG. 4B are schematic diagrams respectively illustrating different implementations of a head mounted display according to another embodiment of the disclosure. In FIG. 4A, a head mounted display 401 includes a first display 410, a first lens 420, a second lens 430, a beam splitter coating 440, a second display 450, a third lens 460, and an actuator 470. The first display 410 has the active surface AF1. The first display 410 is configured to generate the first display image beam on the active surface AF1. The first lens 420 has the first surface SF1 and the second surface SF2. The first surface SF1 of the first lens 420 faces the active surface of the first display 410. The second surface SF2 of the first lens 420 is opposite to the first surface SF1 the first lens 420. The second lens 430 has the third surface SF3 and the fourth surface SF4 opposite to each other. The beam splitter coating 440 is disposed between the second surface SF2 of the first lens 420 and the third surface SF3 of the second lens 430. In the embodiment, the third surface SF3 of the second lens 430 and the second surface SF2 of the first lens 420 are attached to each other through the beam splitter coating 440.

In the embodiment, the first lens 420 is a convex lens, and the second lens 430 is a concave lens. The first display image beam generated on the active surface AF1 of the first display 410 may be projected onto the first surface SF1 of the first lens 420. The first display image beam may be further transmitted to the beam splitter coating 440 on the second surface SF2 of the first lens 420. The beam splitter coating 440 may reflect the received first display image beam to generate a reflection display image beam, and may cause the reflection display image beam to be transmitted through the first display 410 to be projected to the target region TG. The target region TG is the exit pupil position of the head mounted display 401, corresponding to the position of the eyeball of the user of the head mounted display 401. The eyeball of the user of the head mounted display 401 faces the non-active surface NAF1 of the first display 410.

It is noted that, different from the embodiments above, in the head mounted display 401, the third lens 460 and the actuator 470 coupled to the third lens 460 are disposed between the second lens 430 and the second display 450. The actuator 470 is configured to control the third lens 460 to move horizontally, such as to move in a direction HD1 approaching the second lens 430 (away from the second display 450) or to move in a direction HD2 away from the second lens 430 (approaching the second display 450).

The third lens 460 may be a convex lens. By disposing the third lens 460, a focus state of the second display image beam generated by the second display 450 can be adjusted. Within a limited distance between the second lens 430 and the second display 450, a range of the field of view provided by the second display image bean is expanded.

In the embodiment, the actuator 470 may be a motor or a mechanical structure of any form, and a position of the third lens 460 may be adjusted according to an electrical signal or manually by the user.

In FIG. 4B, different from the embodiment in FIG. 4A, in a head mounted display 402, the third lens 460 is disposed between the second lens 430 and the second display 450. The third lens 460 may be a liquid crystal lens. In the embodiment, the curvature of the third lens 460 is adjusted according to an electrical signal CS so that a focal length thereof can be adjusted.

In summary of the above, in the disclosure, a lens group is disposed in the tube of the head mounted display, and the beam splitter coating in the lens group is used to reflect the first display image beam generated by the first display and transmit the second display image beam generated by the second display, thereby expanding the field of view. In this way, the field of view of the head mounted display of the disclosure can be expanded while a lightweight and slim design is maintained, and product competitiveness of the head mounted display can be effectively improved.

1. A head mounted display for virtual reality, comprising:
a first display having an active surface, wherein the first display is a transparent display, and the first display generates a first display image beam on the active surface of the first display;
a first lens having a first surface facing the active surface of the first display and a second surface opposite to the first surface;
a second lens having a third surface and a fourth surface opposite to each other;
a beam splitter coating disposed between the second surface of the first lens and the third surface of the second lens,
wherein the third surface of the second lens and the second surface of the first lens are attached to each other through the beam splitter coating, the first lens is a convex lens, the second lens is a convex lens, and the fourth surface of the second lens is convex; and
a second display having an active surface facing the fourth surface of the second lens, wherein the second display generates a second display image beam on the active surface of the second display.

2. The head mounted display according to claim 1, wherein a non-active surface of the first display is opposite to the active surface of the first display, and the non-active surface of the first display faces a user.

3. The head mounted display according to claim 1, wherein the first surface of the first lens has a first curvature, the second surface of the first lens has a second curvature, an absolute value of the first curvature is less than an absolute value of the second curvature, and the third surface of the second lens has a third curvature.

4. The head mounted display according to claim 3, wherein a sum of the second curvature and the third curvature is 0.

5. The head mounted display according to claim 1, wherein the beam splitter coating reflects the first display image beam and transmits a reflection display image beam to a target region.

6. The head mounted display according to claim 5, wherein the fourth surface of the second lens receives the second display image beam, the beam splitter coating transmits the second display image beam, and the second lens and the first lens focus the second display image beam and cause a focused image beam to be transmitted to the target region.

7. The head mounted display according to claim 1, wherein the second surface of the first lens, the beam splitter coating, and the third surface of the second lens are glued to each other.

8. The head mounted display according to claim 1, wherein the target region is an exit pupil position of the head mounted display.

9. The head mounted display according to claim 1, further comprising:
a third lens disposed between the second lens and the second display and configured to adjust a focus state of the second display image beam.

10. The head mounted display according to claim 9, wherein the third lens is coupled to an actuator, and the actuator is configured to cause the third lens to move horizontally between the second lens and the second display.

11. The head mounted display according to claim 9, wherein the third lens is a liquid crystal lens, and a curvature of the third lens is adjusted according to an electrical signal.
